(19) United States
(12) Patent Application Publication
(10) Pub. No.: US 2010/0049605 A1
(43) Pub. Date: Feb. 25, 2010

(54) ADVERTISEMENT LINKAGE SYSTEM OF MOBILE COMMUNICATION TERMINAL, USING PROXY SERVER

(75) Inventors: Jin Cheon KIM, Yongin-si (KR); Kwang Yul SEO, Seongnam-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Company 100, Inc., Seongnam-si (KR)

(21) Appl. No.: 12/542,456

(22) Filed: Aug. 17, 2009

(30) Foreign Application Priority Data
Aug. 20, 2008 (KR) 10-2008-0081237
Aug. 20, 2008 (KR) 10-2008-0081239
Aug. 6, 2009 (KR) 10-2009-0072295

(51) Int. Cl. G06Q 30/00

(52) U.S. Cl. 705/14.52; 705/14.64

(57) ABSTRACT

An advertisement linkage system of a mobile communication terminal, using a proxy server, includes a mobile communication terminal configured to be inputted with a web address from a user on a web browser built therein, transmit the web address to a proxy server via a wireless network, and display web contents and an advertisement received from the proxy server on a display; the proxy server configured to receive the web address from the terminal, transmit a web page access command to a web server via a wide bandwidth wired network, extract keywords from web contents received from the web server, transmit extracted keywords to an advertisement server, and transmit the web contents and an advertisement received from the advertisement server to the terminal; and the advertisement server configured to search an advertisement most appropriate for the keywords received from the proxy server, and transmit the advertisement to the proxy server.

### BACKGROUND OF THE INVENTION

1. Field of the Invention

The present invention relates to an advertisement linkage technique in a web browser built in a mobile communication terminal, and more particularly, to an advertisement linkage system of a mobile communication terminal, using a proxy server, which, when a mobile communication terminal accesses the Internet through a web browser and requests contents on a web page, transmits requested web contents and an associated advertisement to the web browser, using a proxy server, so that the requested web contents and the associated advertisement can be displayed together.

2. Description of the Related Art

These days, a web browser is considered as an essential tool for accessing the Internet in a mobile communication terminal such as a mobile phone, and so forth, and the importance of the web browser is further elevated due to the activation of the wireless Internet. Recently, as the size of the window of a mobile communication terminal is increased, and the performance of hardware such as a central processing unit (CPU) is improved. Also, the distribution rate of a smartphone, which is equipped with an operation system (OS) capable of performing complicated functions, is significantly increased. Due to this fact, customers' demands for using web sites, which are complicated as in personal computers (PCs) using the HTML (hypertext mark-up language) standards, in addition to very simple web sites, which are dedicated for mobile communication terminals (for example, mobile phones) and employ the existing WAP standards, are gradually increased, and in conformity with this, the mobile Internet advertisement market is growing fast.

So far, in mobile communication terminals, web browser-based advertisement methods are generally realized in two ways.

A first method is the same as Internet advertisement implemented in PCs in that, when the same web site as that used in PCs is used on the web browser of a mobile communication terminal, a user can view the same advertisement as that on the web site used in PCs. A typical example of this method is AdSense of Google, Inc. residing at U.S.A., in which an advertiser registers an advertisement along with keywords and a web page owner registers on AdSense. Thereafter, contents on a web page are analyzed, and an advertisement link having keywords associated with the contents is inserted in the web page and is then transmitted. Thus, a user is incited to click the advertisement, whereby target advertisement can be realized.

A second method is the same as that developed by AdMob, Inc. residing at U.S.A. and uses mobile standards such as WAP, and so forth. This advertising method is basically the same as AdSense of Google, Inc., except that the second method provides service not for usual web sites but for WAP sites. In the second method, an advertiser registers an advertisement along with keywords, and a web page owner makes a WAP-based mobile web site in a way that AdMob supports and registers on the advertisement system of AdMob. Thereafter, the contents of a web page are analyzed, and an advertisement link having keywords associated with the contents is inserted in the web page and is then transmitted. Thus, a user is incited to click the advertisement, whereby target advertisement can be realized.

While AdSense of Google, Inc. is most widely used in PCs, general limitations exist in that the advertisement can be placed on the corresponding web page only when the web page owner registers on AdSense. Also, in the case where the method is applied to the screen of the mobile communication terminal which has a relatively small size compared to the screen of PCs, it is difficult to accomplish the same advertisement effectiveness as in PCs due to the difference in screen size.

Further, the advertisement method such as AdSense has a drawback in that, because only the keywords of the web contents to be accessed are used as input data of advertisement, target advertisement effectiveness can deteriorate.

The advertisement of AdMob, Inc. can achieve the object of the target advertisement since the web site suitable for the mobile communication terminal having a small size is created and the advertisement appropriate for the small size of the mobile communication terminal is inserted. Nevertheless, general limitations exist in that the advertisement can be placed on the corresponding web page only when the web page owner registers on AdMob. Also, the second method suffers from defects in that it can be applied only to the web page which is built in the WAP-based mobile web site.

### SUMMARY OF THE INVENTION

Accordingly, the present invention has been made in an effort to solve the problems occurring in the related art, and an object of the present invention is to provide an advertisement linkage system of a mobile communication terminal, using a proxy server, wherein, when a mobile communication terminal accesses the Internet through a web browser and requests contents on a web page, a proxy server extracts keywords from the contents and acquires terminal information, position information and personal information from the mobile communication terminal and the server of a mobile communication company such that the proxy server is linked with an advertisement system so that target advertisement associated with the web contents can be accomplished on the basis of the information.

In order to achieve the above object, according to one aspect of the present invention, there is provided an advertisement linkage system of a mobile communication terminal, using a proxy server, comprising a mobile communication terminal configured to be inputted with a web address from a user on a web browser built therein, transmit the web address to a proxy server via a wireless network, and display web contents and an advertisement received from the proxy server on a display device; the proxy server configured to receive the web address from the mobile communication terminal, transmit a web page access command to a web server via a wide bandwidth wired network, extract keywords from web contents received from the web server, transmit extracted keywords to an advertisement server, and transmit the web contents and an advertisement received from the advertisement server to the mobile communication terminal; and the advertisement server configured to search an advertisement most appropriate for the keywords received from the proxy server, and transmit the advertisement to the proxy server.

In order to achieve the above object, according to another aspect of the present invention, there is provided an advertisement linkage system of a mobile communication terminal, using a proxy server, comprising a mobile communication terminal configured to transmit a web address to a proxy server via a wireless network along with web contents request information, terminal information, position information of the mobile communication terminal when a user inputs the web address to be accessed on a web browser built in the mobile communication terminal, and display web contents and an advertisement received from the proxy server on a display device; the proxy server configured to transmit a web contents request command corresponding to the web address to a web server, extract keywords based on web contents received from the web server, transmit extracted keywords to the advertisement server along with the position information, and transmit the terminal information to a mobile communication company server; the mobile communication company server configured to extract personal information from the terminal information received from the proxy server, and transmit extracted personal information to the advertisement server; and the advertisement server configured to select, among selectable advertisements, an advertisement most appropriate for the personal information received from the mobile communication company server and the keywords and position information received from the proxy server, and transmit a selected advertisement to the proxy server.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram illustrating an advertisement linkage system of a mobile communication terminal, using a proxy server, in accordance with a first embodiment of the present invention;

FIG. 2 is a block diagram illustrating a variation in which an advertisement is displayed by being inserted into web contents, in the advertisement linkage system of a mobile communication terminal, using a proxy server, in accordance with the first embodiment of the present invention;

FIG. 3 is a block diagram illustrating another variation in which an advertisement is displayed by being inserted into web contents, in the advertisement linkage system of a mobile communication terminal, using a proxy server, in accordance with the first embodiment of the present invention;

FIG. 4 is a block diagram illustrating an advertisement linkage system of a mobile communication terminal, using a proxy server, in accordance with a second embodiment of the present invention;

FIG. 5 is a block diagram illustrating a procedure for realizing target advertisement based on mobile communication terminal information and position information in the advertisement linkage system of a mobile communication terminal, using a proxy server, in accordance with the second embodiment of the present invention; and

FIG. 6 is a block diagram illustrating a procedure for correcting an advertisement target selecting scheme using advertisement selecting information in the advertisement linkage system of a mobile communication terminal, using a proxy server, in accordance with the second embodiment of the present invention.

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

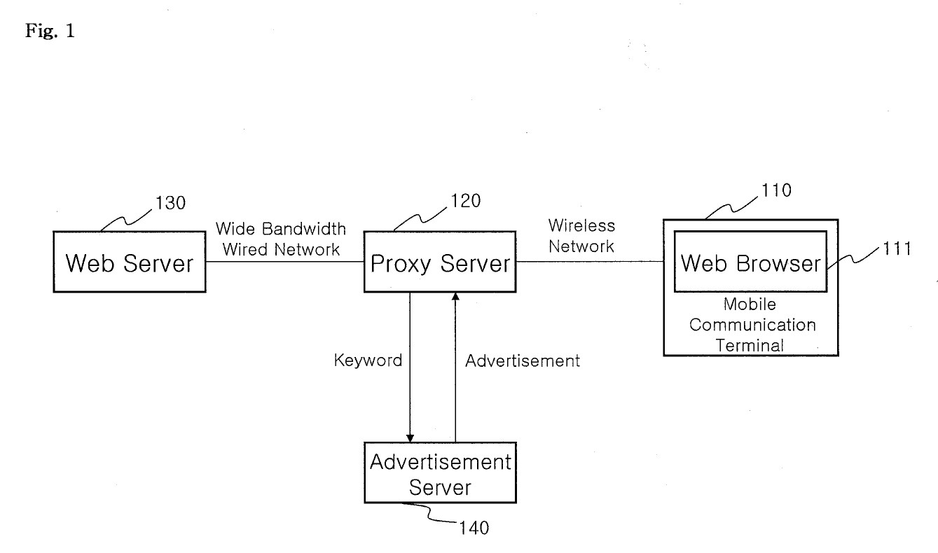

FIG. 1 is a block diagram illustrating an advertisement linkage system of a mobile communication terminal, using a proxy server, in accordance with a first embodiment of the present invention. Referring to FIG. 1, the advertisement linkage system includes a mobile communication terminal 110, a proxy server 120, a web server 130, and an advertisement server 140.

The mobile communication terminal 110 and the proxy server 120 are connected via a wireless network, the proxy server 120 and the web server 130 are connected via a wide bandwidth wired network, and the proxy server 120 and the advertisement server 140 are connected via a wide bandwidth wired network.

First, if a user inputs a web address to be accessed, on a web browser 111 of the mobile communication terminal 110, the web address is transmitted to the proxy server 120 via the wireless network and the Internet.

The proxy server 120 receives the web address from the web browser 111 of the mobile communication terminal 110 and transmits a web page access command to the web server 130 having the corresponding address. The access command is a command according to the HTTP protocol.

The web server 130 receives the web page access command transmitted from the proxy server 120 and transmits the contents of a corresponding web page to the proxy server 120.

The proxy server 120 analyzes the web contents received from the web server 130, extracts keywords, and then, transmits the extracted keywords to the advertisement server 140.

The advertisement server 140 searches an advertisement most appropriate for the keywords received from the proxy server 120, and transmits the corresponding advertisement to the proxy server 120.

The proxy server 120 transmits the web contents received from the web server 130 and the advertisement received from the advertisement server 140 to the mobile communication terminal 110.

Accordingly, the web browser 111 built in the mobile communication terminal 110 displays the web contents and the advertisement which are transmitted from the proxy server 120, on a display device (for example, an LCD), whereby target advertisement is realized.

At this time, in order to increase a processing speed, it is preferred that the web browser 111 not simultaneously but sequentially receive the web contents and the advertisement from the proxy server 120.

To this end, the proxy server 120 receives the web contents from the web server 130 and transmits the web contents to the mobile communication terminal 110. Further, the proxy server 120 analyzes the web contents, extracts keywords, and transmits the keywords to the advertisement server 140. Thereafter, the proxy server 120 transmits the advertisement which is associated with the keywords and is received from the advertisement server 140, to the web browser 111.

Describing an example of the above-described target advertisement, in the case of http://www.cnn.com known among Internet newspapers as a web site most frequently accessed by users, if an earthquake occurs on a day in California, California and earthquake will become words that are most frequently searched on that day. Therefore, in this case, California and earthquake become the keywords. In this connection, if it is determined by the advertisement server 140 that “California Earthquake Shelter” is the most appropriate target, the advertisement link of the “California Earthquake Shelter” is displayed on the web browser 111 of the mobile communication terminal 110 along with http://www.cnn.com.

To this end, the proxy server 120 analyzes the contents of http://www.cnn.com, and transmits the keywords of California and earthquake to the advertisement server 140. Then, the advertisement server 140 transmits the advertisement link to the mobile communication terminal 110 by way of the proxy server 120 so that the advertisement link is displayed on the web browser 111. If a user clicks the displayed link “California Earthquake Shelter,” movement is made to the web page of “California Earthquake Shelter”.

As a consequence, in the advertisement linkage system according to the present invention, the proxy server 120 analyzes the web contents and is connected with the advertisement server 140 such that the advertisement can be displayed on the web browser 111 in a style appropriate for the circumstances for the mobile communication terminal 110, whereby it is possible to overcome the limitations caused in the conventional advertisement systems for mobile communication terminals, such as AdSense of Google, Inc. and the system of AdMob, Inc.

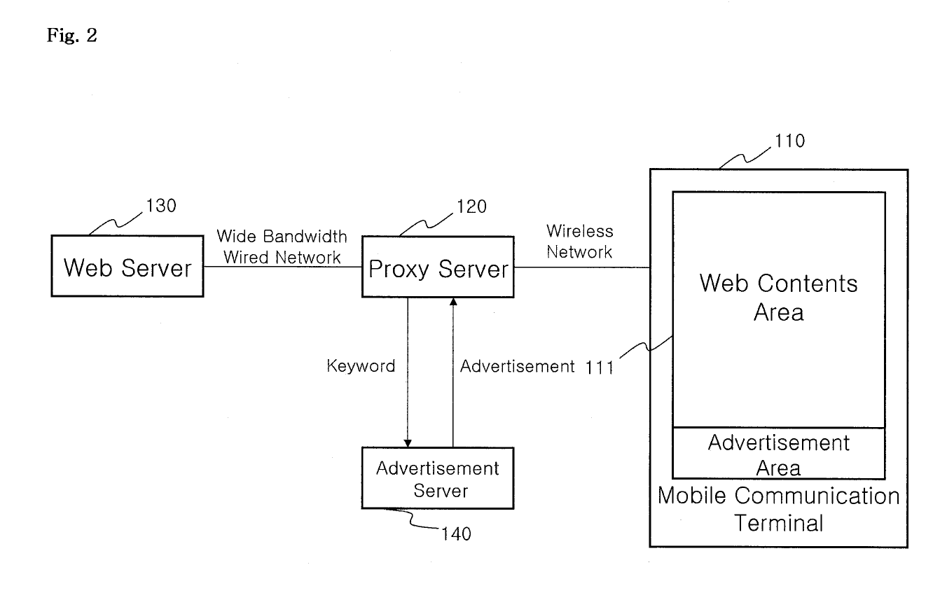

FIG. 2 is a block diagram illustrating a variation in which an advertisement is displayed by being inserted into web contents, in the advertisement linkage system of a mobile communication terminal, using a proxy server, in accordance with the first embodiment of the present invention.

As described above, the mobile communication terminal 110 displays the web contents and the advertisement transmitted from the proxy server 120 on the web browser 111. At this time, the advertisement can be displayed at the periphery (an upper, lower, left or right peripheral portion) of a web contents area on the entire screen in conformity with a setting from the proxy server 120 or a user. FIG. 2 illustrates a state in which the advertisement is displayed on the lower peripheral portion.

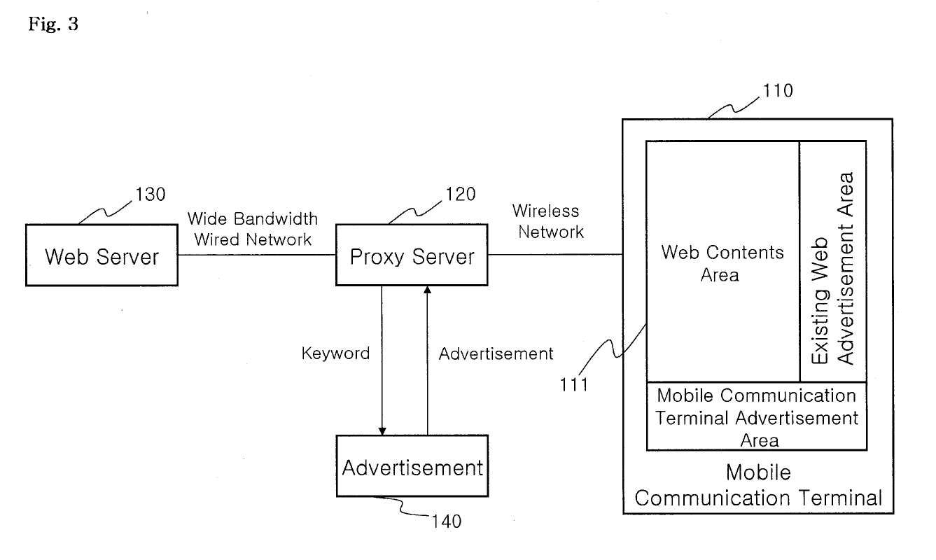

FIG. 3 is a block diagram illustrating another variation in which an advertisement is displayed by being inserted into web contents, in the advertisement linkage system of a mobile communication terminal, using a proxy server, in accordance with the first embodiment of the present invention. In the present variation, the advertisement is displayed in a state in which it is linked with the conventional advertisement system such as AdSense of Google, Inc.

The proxy server 120 searches a web page which is accessed by a user through the web browser 111. When it is determined that the web page is already registered on the conventional advertisement system, the proxy server 120 selects one or two advertisements having highest target rates among the keyword-based target advertisements transmitted from the advertisement server 140 and transmits the selected advertisements to the mobile communication terminal 110.

At this time, the web browser 111 of the mobile communication terminal 110 implements a displaying task by displaying the target advertisements transmitted from the proxy server 120 on the lower peripheral portion of the screen, in such a way as to be linked with the conventional advertisement system.

As shown in FIG. 3, the existing web advertisement is usually displayed at the right side of a web contents area on the screen of the web page. This is because, in a mobile communication terminal such as a mobile phone, and the like, which generally has a small-sized display device (screen), the right portion of the screen does not easily meet a person's eye and advertisement effectiveness thereof is thereby degraded.

The one or two mobile communication terminal advertisements which are selected from the proxy server 120 are always displayed not on the screen of the web page but on the screen of the terminal so that the advertisement effectiveness can be improved. The display area of the advertisements on the mobile communication terminal is not fixed to the lower peripheral portion of the terminal screen, but can be changed to left or right peripheral portion of the screen in conformity with the setting from the proxy server 120 or the user.

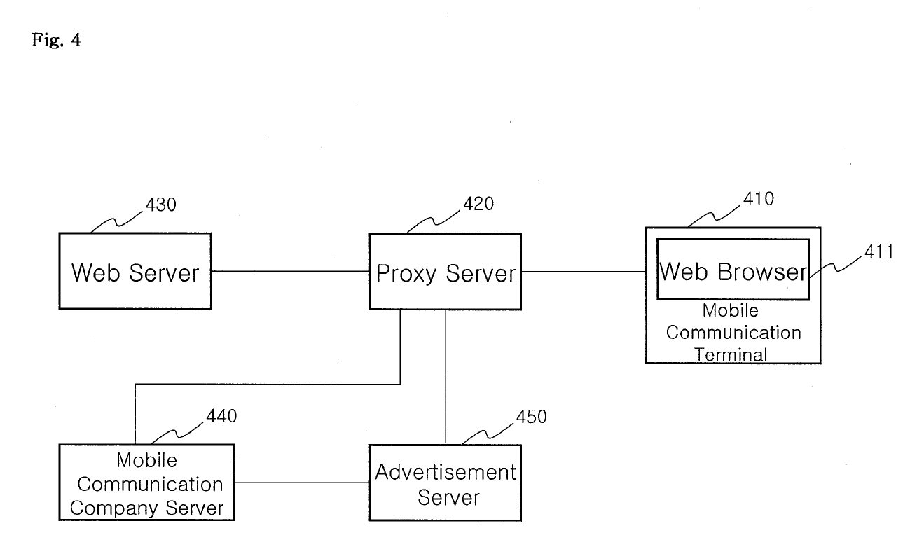

FIG. 4 is a block diagram illustrating an advertisement linkage system of a mobile communication terminal, using a proxy server, in accordance with a second embodiment of the present invention. Referring to FIG. 4, the advertisement linkage system includes a mobile communication terminal 410, a proxy server 420, a web server 430, a mobile communication company server 440, and an advertisement server 450.

The mobile communication terminal 410 and the proxy server 420 are connected via a wireless network or a wide bandwidth network. Besides, the proxy server 420 and the web server 430, the mobile communication company server 440 and the proxy server 420, the mobile communication company server 440 and the advertisement server 450, and the advertisement server 450 and the proxy server 420 are connected via wide bandwidth wired networks.

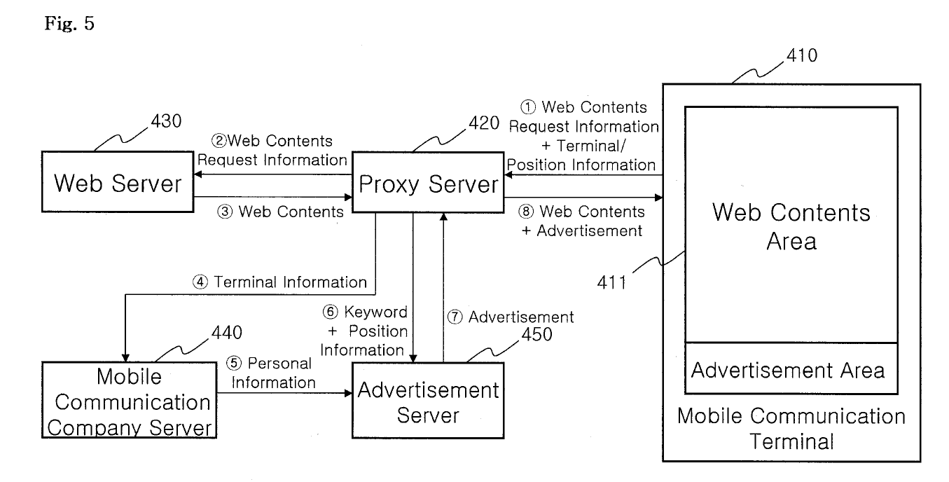

FIG. 5 is a block diagram illustrating a procedure for realizing target advertisement based on mobile communication terminal information and position information in the advertisement linkage system of a mobile communication terminal, using a proxy server, in accordance with the second embodiment of the present invention shown in FIG. 4. The procedure will be described below.

If a user inputs a web address to be accessed on a web browser 411 of the mobile communication terminal 410, the web address is transmitted to the proxy server 420 via the wireless network along with web contents request information, terminal information and position information of the mobile communication terminal 410. \textcircled{1}

The proxy server 420 receives the web address from the web browser 411, and transmits a web page access command (web contents request command) to the web server 430 having the corresponding address. \textcircled{2}

The web server 430 receives the web page access command from the proxy server 420, and transmits the contents of a corresponding web page to the proxy server 420. \textcircled{3}

The proxy server 420 transmits the terminal information received from the web browser 411 to the mobile communication company server 440. \textcircled{4}

The mobile communication company server 440 extracts personal information from the terminal information received from the proxy server 420, and transmits the extracted personal information to the advertisement server 450. \textcircled{5}

The proxy server 420 extracts keywords based on the web contents received from the web server 430, and transmits the extracted keywords to the advertisement server 450 along with the position information. \textcircled{6}

The advertisement server 450 selects, among selectable advertisements, an advertisement most appropriate for the personal information received from the mobile communication company server 440 and the keywords and position information received from the proxy server 420, and transmits the selected advertisement to the proxy server 420. \textcircled{7}

The proxy server 420 transmits the advertisement received from the advertisement server 450 to the web browser 411 of the mobile communication terminal 410 along with the web contents received from the web server 430. \textcircled{8}

The web browser 411 of the mobile communication terminal 410 displays the web contents and the advertisement received from the proxy server 420 on a display device (for example, an LCD), whereby target advertisement is realized.

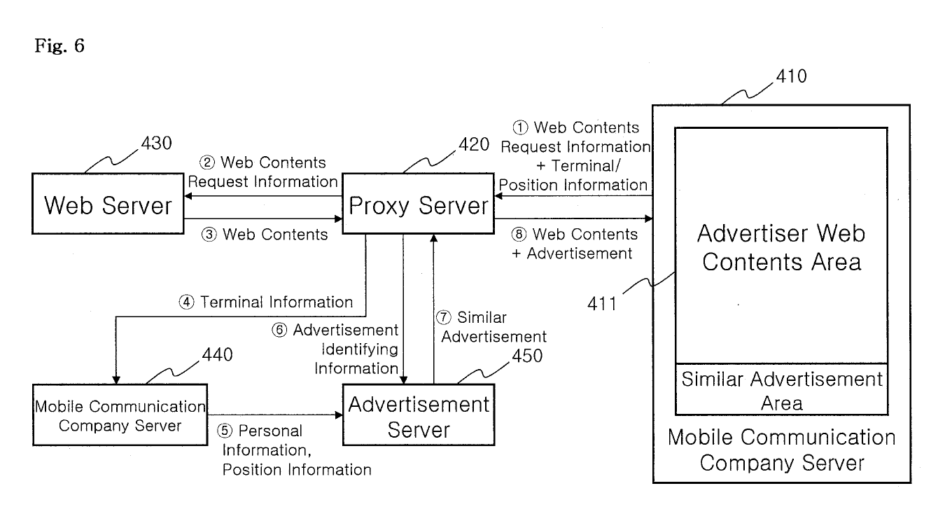

FIG. 6 is a block diagram illustrating a procedure for correcting an advertisement target selecting scheme using advertisement selecting information in the advertisement linkage system of a mobile communication terminal, using a proxy server, in accordance with the second embodiment of the present invention shown in FIG. 4. The procedure will be described below.

If a user clicks an advertisement on the web browser 411 of the mobile communication terminal 410, corresponding web contents request information is transmitted to the proxy server 420 via the wireless network along with terminal information and position information of the mobile communication terminal 410. \textcircled{1}

The proxy server 420 receives the web contents request information from the web browser 411, and transmits a web page access command (web contents request command) to the web server 430 having the corresponding address. \textcircled{2}

The web server 430 receives the web page access command from, the proxy server 420, and transmits the contents of a corresponding web page to the proxy server 420. \textcircled{3}

The proxy server 420 transmits the terminal information received from the web browser 411 to the mobile communication company server 440. \textcircled{4}

The mobile communication company server 440 extracts personal information of the terminal user from the terminal information received from the proxy server 420, and transmits the extracted personal information to the advertisement server 450 along with position information. \textcircled{5}

The proxy server 420 transmits advertisement identifying information to the advertisement server 450. \textcircled{6}

The advertisement server 450 implements synthetic analysis regarding when, where and by whom the advertisement previously transmitted by the advertisement server 450 is clicked, based on the personal information and position information received from the mobile communication company server 440 and the advertisement identifying information received from the proxy server 420. Further, the advertisement server 450 corrects a target advertisement selecting scheme based on the analysis results so that a target advertisement can be more precisely selected thereafter than when an advertisement is selected by receiving keywords.

With regard to the advertisement currently clicked by the user, the advertisement server 450 selects an advertisement similar to the currently clicked advertisement based on the advertisement identifying information received from the proxy server 420, and transmits the selected similar advertisement to the proxy server 420. \textcircled{7}

The proxy server 420 transmits the similar advertisement received from the advertisement server 450 to the web browser 411 of the mobile communication terminal 410 along with the web contents received from the web server 430. \textcircled{8}

The web browser 411 of the mobile communication terminal 410 displays the web contents received from the proxy server 420 on a display device and the similar advertisement on the lower peripheral portion of the display device, whereby target advertisement is realized.

As is apparent from the above description, in the present invention, a proxy server analyzes all web pages to be accessed by a user on the web browser of a mobile communication terminal so that keyword-based target advertisement can be realized, whereby advertisement effectiveness can be improved when using the Internet on the mobile communication terminal.

Also, as mobile communication terminal information and position information are added to web contents keywords, the target advertisement can be effectively realized using the information under mobile communication circumstances.

Further, when the user clicks an advertisement on the web browser of the mobile communication terminal, user information and position information of the mobile communication terminal are used to realize the target advertisement, whereby comparison between advertisements is incited, so advertisement selection rate can be improved.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. An advertisement linkage system of a mobile communication terminal, using a proxy server, comprising:
a mobile communication terminal configured to be inputted with a web address from a user on a web browser built therein, transmit the web address to a proxy server via a wireless network, and display web contents and an advertisement received from the proxy server on a display device;
the proxy server configured to receive the web address from the mobile communication terminal, transmit a web page access command to a web server via a wide bandwidth wired network, extract keywords from web contents received from the web server, transmit extracted keywords to an advertisement server, and transmit the web contents and an advertisement received from the advertisement server to the mobile communication terminal; and
the advertisement server configured to search an advertisement most appropriate for the keywords received from the proxy server, and transmit the advertisement to the proxy server.

2. The advertisement linkage system according to claim 1, wherein the mobile communication terminal displays the advertisement on a lower end portion of a web contents area when displaying the web contents and the advertisement on the web browser.

3. The advertisement linkage system according to claim 1, wherein, when displaying the web contents and the advertisement, the mobile communication terminal displays an existing web advertisement at a right side of a web contents area on a screen of a web page, and displays the advertisement of the mobile communication terminal received from the proxy server on a lower end portion of a terminal screen.

4. The advertisement linkage system according to claim 1, wherein the proxy server first transmits the web contents received from the web server to the mobile communication terminal, and then transmits the advertisement received from the advertisement server to the mobile communication terminal.

5. The advertisement linkage system according to claim 1, wherein, when the proxy server searches a web page accessed by the user through the web browser, if it is determined that the web page is already registered on an existing advertisement system, the proxy server selects one or two advertisements having highest target rates among keyword-based target advertisements transmitted from the advertisement server, and transmits the selected advertisements to the mobile communication terminal.

6. An advertisement linkage system of a mobile communication terminal, using a proxy server, comprising:
a mobile communication terminal configured to transmit a web address to a proxy server via a wireless network along with web contents request information, terminal information, position information of the mobile communication terminal when a user inputs the web address to be accessed on a web browser built in the mobile communication terminal, and display web contents and an advertisement received from the proxy server on a display device;
the proxy server configured to transmit a web contents request command corresponding to the web address to a web server, extract keywords based on web contents received from the web server, transmit extracted keywords to the advertisement server along with the position information, and transmit the terminal information to a mobile communication company server;
the mobile communication company server configured to extract personal information from the terminal information received from the proxy server, and transmit extracted personal information to the advertisement server; and
the advertisement server configured to select, among selectable advertisements, an advertisement most appropriate for the personal information received from the mobile communication company server and the keywords and position information received from the proxy server, and transmit a selected advertisement to the proxy server.

7. The advertisement linkage system according to claim 6, wherein the mobile communication company server extracts personal information of a terminal user from the terminal information received from the proxy server, and transmits the personal information to the advertisement server along with position information.

8. The advertisement linkage system according to claim 6, wherein the advertisement server implements synthetic analysis regarding when, where and by whom an advertisement previously transmitted by the advertisement server is clicked, based on the personal information and position information received from the mobile communication company server and advertisement identifying information received from the proxy server, and corrects a target advertisement selecting scheme based on analysis results so that a target advertisement can be more precisely selected thereafter than when an advertisement is selected by receiving keywords.

9. The advertisement linkage system according to claim 6, wherein, with regard to an advertisement currently clicked by the user, the advertisement server selects an advertisement similar to the currently clicked advertisement based on the advertisement identifying information received from the proxy server, and transmits the selected similar advertisement to the proxy server.
